(19) United States
(12) Patent Application Publication
(10) Pub. No.: US 2008/0115668 A1
(43) Pub. Date: May 22, 2008

(54) Arrangement For Cleaning Filter Apparatus Of Rock Drilling Rig

(75) Inventors: Ari Haavisto, Lempaala (FI); Kari Juujarvi, Nokia (FI)

Correspondence Address: DRINKER BIDDLE & REATH (DC), 1500 K STREET, N.W., SUITE 1100, WASHINGTON, DC, 20005-1209, US

(73) Assignee: SANDVIK MINING AND CONSTRUCTION OY, Tampere (FI)

(21) Appl. No.: 11/666,355

(22) PCT Filed: Oct. 26, 2005
(86) PCT No.: PCT/FI05/50374

§ 371 Date: Apr. 26, 2007

(30) Foreign Application Priority Data
Oct. 27, 2004 (FI) 20045405

(51) Int. Cl. B01D 46/04

(52) U.S. Cl. 95/280; 55/287; 55/283

(57) ABSTRACT

A method for cleaning a filter apparatus of a rock drilling rig, a filter apparatus and a rock drilling rig. The filter apparatus comprises several filter units, and the filters therein separate solid matter from the filtering flow. The filter apparatus comprises a cleaning apparatus with a pressure channel enabling to provide the filter unit to be cleaned with a pressure pulse. The cleaning apparatus also comprises mechanical sealing means for preventing the filtering flow through the filter unit to be cleaned during cleaning.

### BACKGROUND OF THE INVENTION

The invention relates to a method for cleaning a filter apparatus of a rock drilling rig, the filter apparatus comprising several filter units, each one of which being provided with a filter for separating solid matter from the filtering flow to be conducted through the filter unit, and the method comprising removing the solid matter adhered to the filter by providing the filter unit to be cleaned by means of a cleaning apparatus with a pressure pulse, the flow direction of which is reverse in comparison with the flow direction of conventional filtering.

The invention also relates to a filter apparatus comprising: a frame, a first chamber, into which the flow to be filtered is conducted from a suction channel, a second chamber, from where the filtered flow is arranged to be discharged to a discharge channel, several filter units arranged between the first and the second chamber, each one of which comprising a filter, and through which filter units the filter flow is arranged to pass, whereby the filters are arranged to retain the solid matter in the filtering flow, a cleaning apparatus comprising at least one pressure channel enabling to provide at least one filter unit to be cleaned at a time with a pressure pulse, the direction of which is reverse in comparison with the conventional filtering flow, whereby the pressure pulse is arranged to remove the solid matter in the filter, and at least one control unit for controlling the operation of the cleaning apparatus.

The invention further relates to a rock drilling rig comprising: a movable carrier provided with at least one drilling boom, the outermost end thereof comprising a rock drilling unit including at least a feed beam and a rock drilling machine, a dust collection system including at least one suction apparatus, a filter apparatus and at least one suction channel, the dust collection system also being arranged to suck dust from a drilling hole drilled with the rock drilling machine, and the filter apparatus further comprising: a frame, a first chamber, into which the flow to be filtered is conducted from the suction channel, a second chamber, from where the filtered flow is arranged to be discharged to a discharge channel, several filter units arranged between the first chamber and the second chamber, each one of which comprising a filter, and through which filter units the filter flow is arranged to pass, whereby the filters are arranged to retain the solid matter in the filtering flow, a cleaning apparatus comprising at least one pressure channel enabling to provide at least one filter unit to be cleaned with a pressure pulse, the direction of which is reverse in comparison with the conventional filtering flow, whereby the pressure pulse is arranged to remove the solid matter in the filter, and at least one control unit for controlling the operation of the cleaning apparatus.

A large amount of dust is created when holes are drilled into a rock. A rock drilling rig may be provided with a dust collection system that sucks the dust created and moves the dust to a filter apparatus, where air and solid matter are separated. However, rock dust easily clogs the filters in a filter apparatus, thus weakening the efficiency of the filtering. Increasing the number of filters enables to increase the capacity of the filter apparatus, but then the massive size and the high costs become a problem. Cleaning apparatuses have therefore been developed, which create a pressure pulse inside the filter, the direction of which is reverse in comparison with the conventional suction flow of the filter. The pressure pulse removes the solid matter adhered to the filter. Publication GB 812 244 discloses an example of such a cleaning apparatus. However, a problem with the known solutions is that at least some of the dust removed from the filter immediately returns by impact of the suction to the filter, from where it was removed by means of the pressure pulse. The current cleaning apparatuses are therefore unable to efficiently clean the filter units.

### BRIEF DESCRIPTION OF THE INVENTION

It is an object of the present invention to provide a new and improved method for cleaning a filter apparatus of a rock drilling rig, a filter apparatus and a rock drilling rig.

The method of the invention is characterized by preventing the filtering flow through the filter unit to be cleaned by means of mechanical sealing means during cleaning, and keeping the filter unit to be cleaned sealed for a predetermined time after having provided the pressure pulse.

The filter apparatus of the invention is characterized in that the cleaning apparatus comprises mechanical sealing means for preventing the filtering flow through at least one filter unit to be cleaned during cleaning, and the control unit is arranged to keep the filter unit to be cleaned sealed for a predetermined time after having provided the pressure pulse.

The rock drilling rig of the invention is characterized in that the cleaning apparatus comprises mechanical sealing means for preventing the filtering flow through at least one filter unit to be cleaned during cleaning, and the control unit is arranged to keep the filter unit to be cleaned sealed for a predetermined time after having provided the pressure pulse.

It is an essential idea of the invention to separate one or more filter units to be cleaned by means of sealing means from the filtering flow conducted through the filter apparatus during cleaning. After sealing, the filter unit to be cleaned is provided with one or more pressure pulses. The flow direction of the pressure pulse is reverse to the conventional flow direction of the filter unit to be cleaned. Furthermore, the filter unit to be cleaned is kept sealed for a predetermined time after having provided the pressure pulse. Filtering in the filter units, which are not to be cleaned, is continued in a substantially unchanged manner.

An advantage of the invention is that the dust and other solid matter removed from the filter is allowed to undisturbedly fall towards the bottom of the filter apparatus before the suction flow is again passed through the filter unit. Thus the removed dust is not immediately returned to the cleaned filter. The cleaning is therefore more efficient than before. When the cleaning is efficient then the filter apparatus can be dimensioned to be of a smaller size than previously, and in addition the filters endure longer than before.

An essential idea of an embodiment of the invention is that the filter unit to be cleaned is kept sealed for at least one second after having provided the pressure pulse.

An essential idea of an embodiment of the invention is that the sealing means comprise a funnel, which can be arranged substantially gas-tightly against at least one filter unit so that the suction flow through the filter unit in question is prevented.

An essential idea of an embodiment of the invention is that the cleaning apparatus is moved in relation to the filter units and the cleaning apparatus is placed at the location of the filter unit to be cleaned. The cleaning apparatus may comprise an actuator that allows transferring the pressure channel and the sealing means to the location of each filter unit.

An essential idea of an embodiment of the invention is that the filter units are moved in relation to the cleaning apparatus. The filter units may be arranged on an appropriate circumference in the frame of the filter apparatus, and the frame can be revolved in relation to the middle axle of the frame so that each filter unit can in turn be indexed at the location of the cleaning apparatus.

An essential idea of an embodiment of the invention is that each filter unit is provided with a valve that can be closed so that the suction flow through the filter unit can be prevented for the duration of the cleaning. Furthermore, a specific pressure channel is directed to each filter unit in order to provide a pressure pulse.

An essential idea of an embodiment of the invention is that the suction flow through the filter unit to be cleaned is prevented for the duration of the sealing, the length of which is proportional to the magnitude of the suction formed in the suction unit. The sealing time can be arranged to be longer, the greater the suction to be employed is. The length of the sealing time is also proportional to the distance that the removed solid matter is able to move from the filter unit. A great suction effect may suck the removed solid matter back to the filter unit to be cleaned from a longer distance than a small suction effect, and therefore the sealing time should be longer when a great suction effect is used.

An essential idea of an embodiment of the invention is that the filter unit is cleaned during rock drilling. When the filter unit is cleaned at intervals during conventional drilling, no large amounts of solid matter is collected in the filter unit that could, if a large amount of solid matter were removed in one go, clog the dust separator.

### BRIEF DESCRIPTION OF THE DRAWINGS

The invention is described in more detail in the accompanying drawings, in which

FIG. 1 schematically shows a rock drilling rig provided with a dust collection system,

FIG. 2 schematically shows a side view of a filter apparatus according to the invention,

FIG. 3 schematically shows a side view of a second filter apparatus according to the invention,

FIG. 4 schematically shows a side view of a third filter apparatus according to the invention,

FIG. 5 schematically shows a top view of the principle of the filter apparatus shown in FIG. 4.

For clarity, some embodiments of the invention are shown in simplified form in the Figures. Similar parts are indicated with the same reference numerals in the Figures.

### DETAILED DESCRIPTION OF SOME EMBODIMENTS OF THE INVENTION

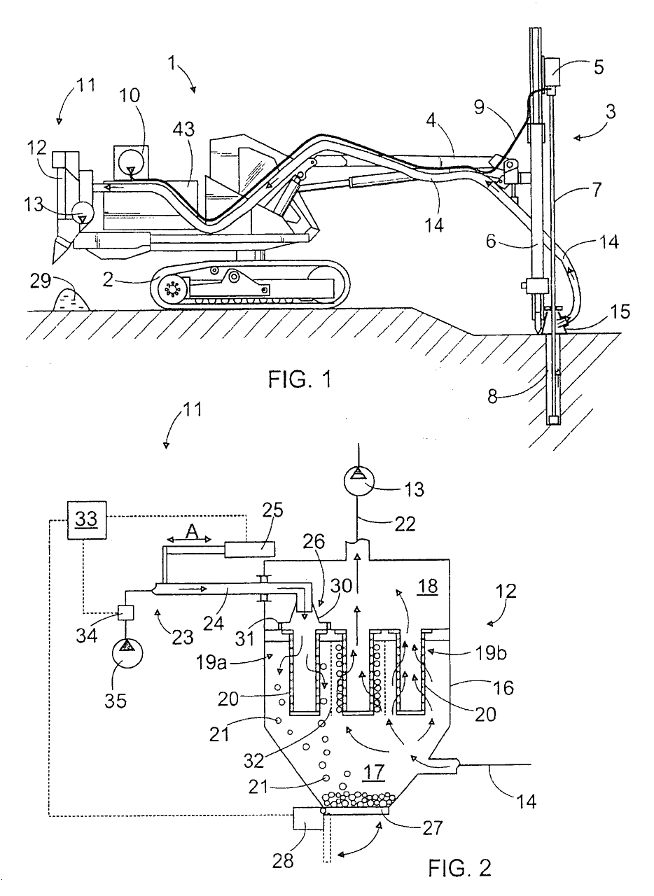

FIG. 1 shows a rock drilling rig 1 comprising a movable carrier 2, on which one or more drilling booms 4 provided with a rock drilling unit 3 are arranged. The rock drilling unit 3 may include a rock drilling machine 5, which is movable on a feed beam 6. The rock drilling machine 5 includes a percussion device, which can be used to provide impact pulses for a tool 7, which influenced by the impact pulses, breaks the rock and forms a drilling hole 8. The drill cuttings created during drilling, meaning dust and other types of rock material, are flushed during drilling from the drilling hole 8. A flushing medium can be supplied along a flushing agent channel 9 and also along the tool 7 to the drilling hole 8, for instance pressure air that pushes the drill cuttings towards the mouth of the drilling hole 8. For the supply of flushing medium the rock drilling rig 1 may comprise for instance a compressor 10. Furthermore, the rock drilling rig 1 may comprise a dust collection system that sucks the drill cuttings from the mouth of the drilling hole 8 and moves said cuttings to the suction unit 11, which may be located at the rear end of the rock drilling rig 1. The suction unit 11 may comprise a filter apparatus 12 that separates solid material and air. The negative pressure required by the dust collection system can be formed by means of one or more suction apparatuses 13. The suction apparatus 13 is connected to one or more suction channels 14, the outermost end of which may be provided with a suction funnel 15 arranged at the mouth of the drilling hole 8. The dust collection system may further comprise one or more coarse separators for filtering coarse rock material.

FIG. 2 illustrates the operating principle of a filter apparatus 12. The filter apparatus 12 may comprise a frame 16 that may form a closed and surrounding outer casing for the filter apparatus 12. The frame may include a first chamber 17 and a second chamber 18. The suction channel 14 can be connected to the first chamber 17. Furthermore, two or more filter units 19 can be arranged between the first chamber and the second chamber 18 and through a filter 20 in said filter units the air arriving from the suction channel 14 is arranged to pass. The filter 20 may comprise small pores or openings, through which air flows, but the filter 20 is able to retain the solid matter 21 such as dust and other types of rock material. The air that has passed the filter 20 flows to the second chamber 18 and forward from there to a discharge channel 22. In the Figures the air flows are illustrated by arrows. The negative pressure required by the suction unit 11 can be formed using the suction apparatus 13 that may be connected to the discharge channel 22. Alternatively the suction apparatus 13 may be located before the filter apparatus 12, in which case the air to be filtered passes in pressurized form through the filter apparatus 12. During filtering the solid matter 21 is collected on the surface of the filter 20, whereby the filter 20 gradually looses the filtering ability thereof and eventually becomes completely clogged. The filter apparatus 12 may therefore be provided with a cleaning apparatus 23, which may comprise a pressure channel 24 that can be moved using an actuator 25 in relation to the filter units 19. The outermost end of the pressure channel 24 may be provided with sealing means 26 that seal the filter unit 19a to be cleaned so that no suction occurs through it. Then a pressure pulse to be provided therethrough efficiently removes the solid matter 21 adhered to the filter 20. Since no suction effect is placed upon the filter unit 19a to be cleaned the solid matter 21 falls freely onto the bottom of the first chamber 17 without the solid matter 21 immediately returning to the filter 20 by impact of the suction. The bottom of the first chamber 17 may be provided with a hatch 27 or the like that can be opened using an actuator 28, in which case the solid matter 21 is allowed to fall to the ground and form a pile 29 as shown in FIG. 1, or alternatively the solid matter 21 is dropped to another appropriate place. The filter unit 19a can be cleaned at intervals during conventional rock drilling without interrupting drilling. Then, the removal of solid matter 21 takes place more evenly and in a more controlled manner than in such solutions, in which the cleaning is carried out when rock drilling is interrupted, for instance when changing a drill rod. When cleaning is carried out during drilling the cleaning can take place often enough so that the amount of solid matter 21 to be removed during one cleaning is relatively small. This allows preventing clogging in the lower part of the filter apparatus 12, i.e. the discharge side, as well as other problems associated with the treatment of the removed solid matter 21.

FIG. 2 shows that the outermost end of the pressure channel 24 may be provided with a funnel 30 that may be provided with seals 31, or the funnel 30 itself may be made of elastic material so that it may be sealed against the upper part of the filter unit 19 and prevent the suction flow through it. The sealing means 26 can be dimensioned such that they separate one filter unit 19a to be cleaned at a time from the other filter units 19b. Alternatively the sealing means 26 may be dimensioned such that they simultaneously separate two or more filter units 19a for cleaning. It is also possible that there may also be several pressure channels 24 and that the cleaning takes place simultaneously from several filter units 19a. The filter units 19b, which are not separated by the sealing means 26, continue the normal operation thereof. The capacity of the filter apparatus 12 and the number of filter units 19 may be dimensioned so that the normal filtering process is not substantially disturbed by the cleaning measures.

What can be arranged between adjacent filter units 19 are walls 32, in which case the suction of the filter unit 19b operating normally is unable to affect the filter unit 19a to be cleaned, whereby the solid matter 21 to be removed in the cleaning will fall onto the bottom of the filter apparatus 21 by the force of gravity.

The pressure channel 24 can be moved in transverse direction A of the filter units 19 for instance by means of a cylinder operating by pressure medium. The filter apparatus 21 may be provided with a control unit 33, which can be arranged to control both the actuator 25 and a control device 34 for example a valve for conducting a pressure pulse from a pressure source 35, for instance from a pump to the pressure channel 24. In addition, the control unit 33 may control the actuator 28 to open and close the hatch 27.

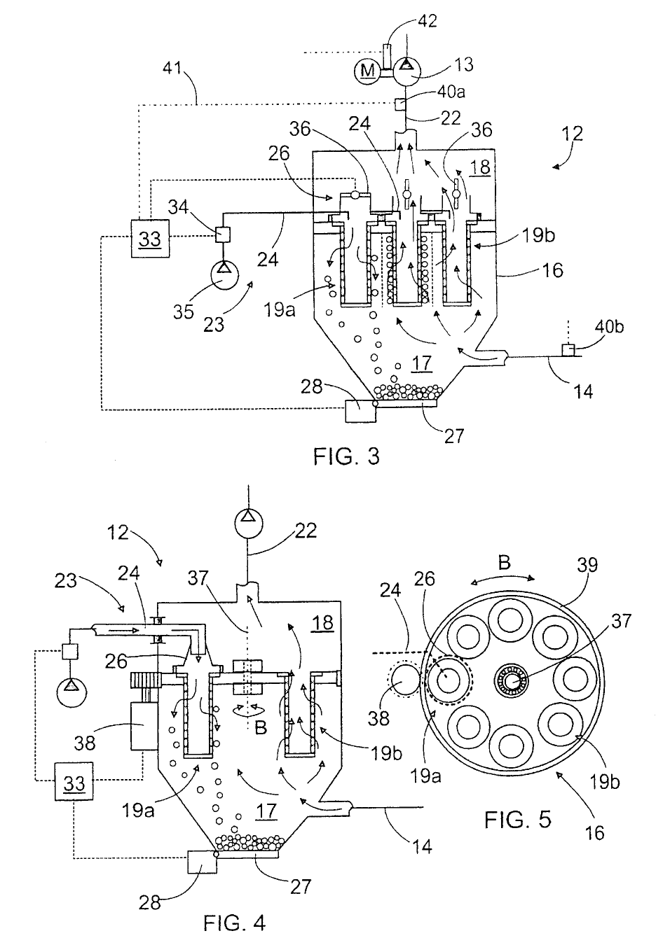

The filter apparatus 21 shown in FIG. 3 comprises sealing means 26 in connection with each filter unit 19. Thus, the upper end of each filter unit 19 can be provided with a valve 36 that can be opened and closed when controlled by the control unit 33. Closing the valve 36 allows the filter unit 19b to be cleaned to be separated from the other filter units 19b, which continue the conventional filtering operation. In addition, a pressure channel 24 leads to the upper end of each filter unit 19, along which channel a pressure pulse from the pressure source 35 can be conducted after the valve 36 has been closed. In this way the suction effect is not substantially subjected at all on the filter unit 19a to be cleaned, in which case the pressure pulse is able to efficiently remove the solid matter adhered to the filter 20 that is allowed to freely fall onto the bottom of the first chamber 17.

The control unit 33 can be arranged to control the operation of the cleaning apparatus 23 in such a manner that the filter unit 19a to be cleaned is kept sealed for a predetermined time after having provided the pressure pulse. The control unit 33 may be provided with a timer that allows determining the sealing time. The sealing time after the pressure pulse may range between 1 and 5 seconds. The solid matter removed is able to move sufficiently far from the filter unit 19a during the sealing time.

Furthermore, the filter unit to be cleaned can be kept sealed for the sealing time, the length of which is proportional to the magnitude of the suction formed by the suction apparatus 13. The magnitude of the suction can be measured using an appropriate measuring device 40a, 40b, a sensor or the like, for instance from the discharge channel 22 or alternatively from the suction channel 14. The measuring information can be forwarded to the control unit 33 along an appropriate data transmission connection 41. It is also possible to determine in the control unit 33 the magnitude of the suction, for instance based on the running speed of the suction apparatus 13 or the driving motor M thereof. For this purpose one or more measuring devices 42, sensors or the like can be arranged at the suction apparatus 13. In addition, the magnitude of the suction may be dependent on the load of a main engine 43 of the rock drilling rig 1, such as a diesel engine or an electric motor. Thus the load of the main engine 43 can be determined and the sealing time can be adjusted proportionally thereto. Other methods are also applicable for determining the magnitude of the suction or the suction effect. The sealing time can be arranged in the control unit 33 to be longer, the greater the suction to be used is. The length of the sealing time is also proportional to the distance that the removed solid matter is able to move away from the filter unit 19a. A significant suction effect is able to suck the removed solid matter back to the filter unit 19a to be cleaned from a longer distance than an insignificant suction effect, and the sealing time should therefore be longer when significant suction is used. The control unit 33 may be provided with a pre-set control strategy, or a control strategy may be set on the basis of which the sealing time is determined in respect of the magnitude of the suction. The above components and measures associated with determining the sealing time are not restricted to be used only with the filter apparatus 12 according to FIG. 3 but can be applied in different embodiments of the invention.

FIG. 4 shows a filter apparatus 21 provided with a frame 16 that is movable in relation to the cleaning apparatus 23. For this purpose the frame 16 is rotatably arranged in relation to a turning axis 37, whereby it can be rotated with a rotating device 38. Alternatively the rotating device 38 is arranged to move only the filter units 19, which may be arranged in a rotating part rotatable in respect of the turning axis 37. The control unit 33 may index either the frame 16 or the rotating part by moving the filter unit 19a to be cleaned to the location of the cleaning apparatus 23. The sealing means 26 arranged in the cleaning apparatus 23 may close the upper side of the filter unit 19a, and thereafter one or more pressure pulses may be provided from the pressure channel 24 in order to remove the solid matter 21. As FIG. 4 shows the outer circumference of the frame 16 may be provided with a toothing 39 that allows the rotating device 38 to rotate the frame 16 and the filter units 19 in direction B. The structure of the filter apparatus 21 may thus be of revolving type, meaning that the filter units 19 may be placed on the circumference. It is also possible to arrange the filter units 19 on more than one circumference. Then the cleaning apparatus 23 may comprise specific cleaning elements for each circumference or alternatively the cleaning apparatus can be moved from one circumference to another. It is also possible that the frame 16 of the filter apparatus 21 is moved linearly in relation to the cleaning apparatus 23.

It should be mentioned that the different embodiments and properties of the invention presented in this application can be combined in order to form various combinations. In some cases the solutions shown may be applied as such regardless of the other properties presented.

The drawings and the specification associated therewith are merely intended to illustrate the idea of the invention. The details of the invention may vary within the scope of the claims.

1. A method for cleaning a filter apparatus of a rock drilling rig, the filter apparatus (12) comprising several filter units (19), each one of which being provided with a filter (20) for separating solid matter (21) from the filtering flow to be conducted through the filter unit (19),
the method comprising:
removing the solid matter (21) adhered to the filter (20) by providing the filter unit (19a) to be cleaned by means of a cleaning apparatus (23) with a pressure pulse, the flow direction of which is reverse in comparison with the flow direction of conventional filtering,
characterized by
preventing the filtering flow through the filter unit (19a) to be cleaned by means of mechanical sealing means (26) during cleaning, and
keeping the filter unit (19a) to be cleaned sealed for a predetermined time after having provided the pressure pulse.

2. A method as claimed in claim 1, characterized by
moving the cleaning apparatus (23) in respect of the filter units (19), and
placing the cleaning apparatus (23) at the location of the filter unit (19a) to be cleaned for cleaning.

3. A method as claimed in claim 1, characterized by
moving the filter units (19) in respect of the cleaning apparatus (23), and
indexing each filter unit (19) in turn at the location of the cleaning apparatus (23) for cleaning.

4. A method as claimed in any one of the preceding claims, characterized by keeping the filter unit (19a) to be cleaned sealed for at least one second after having provided the pressure pulse.

5. A method as claimed in any one of the preceding claims, characterized by
determining the magnitude of the suction formed by a suction unit (11), and
preventing the suction flow through the filter unit (19a) to be cleaned for the sealing time, the length of which is proportional to the magnitude of the suction.

6. A method as claimed in any one of the preceding claims, characterized by
cleaning the filter units (19a) during rock drilling without interrupting the rock drilling.

7. A filter apparatus comprising:
a frame (16),
a first chamber (17), into which the flow to be filtered is conducted from a suction channel (14),
a second chamber (18), from where the filtered flow is arranged to be discharged to a discharge channel (22),
several filter units (19) arranged between the first chamber (17) and the second chamber (18), each one of which comprising a filter (20), and through which filter units (19) the filter flow is arranged to pass, whereby the filters (20) are arranged to retain the solid matter (21) in the filtering flow,
a cleaning apparatus (23) comprising at least one pressure channel (24) enabling to provide at least one filter unit (19a) to be cleaned at a time with a pressure pulse, the direction of which is reverse in comparison with the conventional filtering flow, whereby the pressure pulse is arranged to remove the solid matter (21) in the filter (20), and
at least one control unit (33) for controlling the operation of the cleaning apparatus (23),
characterized in that
the cleaning apparatus (23) comprises mechanical sealing means (26) for preventing the filtering flow through at least one filter unit (19a) to be cleaned during cleaning, and
the control unit (33) is arranged to keep the filter unit (19a) to be cleaned sealed for a predetermined time after having provided the pressure pulse.

8. A filter apparatus as claimed in claim 7, characterized in that
the sealing means (26) are arranged at the outermost end of the pressure channel (24), and
the cleaning apparatus (23) comprises at least one actuator (25) for moving the pressure channel (24) in respect of the filter units (19).

9. A filter apparatus as claimed in claim 7, characterized in that
the outermost end of the pressure channel (24) is provided with sealing means (26),
the pressure channel (24) is immovably arranged in respect of the frame (16),
the filter units (19) are arranged on a circumference of predetermined magnitude,
the filter units (19) are rotatably arranged in relation to a turning axis (37), and
the filter apparatus (12) comprises a rotating device (38) for indexing the filter units (19) at the location of the sealing means (26) for cleaning.

10. A filter apparatus as claimed in claim 7, characterized in
that each filter unit (19) is provided with sealing means (26) that can be opened and closed, and
each filter unit (19) is provided with a specific pressure channel (24).

11. A filter apparatus as claimed in any one of claims 7 to 10, characterized in that
the control unit (33) is arranged to set the duration of the sealing time of the filter unit (19a) to be cleaned in relation to the magnitude of the suction formed by the suction unit (11).

12. A rock drilling rig comprising:
a movable carrier (2) provided with at least one drilling boom (4), the outermost end thereof comprising a rock drilling unit (3) including at least one feed beam (6) and a rock drilling machine (5),
a dust collection system including at least one suction apparatus (13), a filter apparatus (12) and at least one suction channel (14), the dust collection system also being arranged to suck dust from a drilling hole (8) drilled with the rock drilling machine (5),
and the filter apparatus (12) further comprising:
a frame (16),
a first chamber (17), into which the flow to be filtered is conducted from the suction channel (14),
a second chamber (18), from where the filtered flow is arranged to be discharged to a discharge channel (22),
several filter units (19) arranged between the first chamber (17) and the second chamber (18), each one of which comprising a filter (20), and through which filter units (19) the filter flow is arranged to pass, whereby the filters (20) are arranged to retain the solid matter (21) in the filtering flow,
a cleaning apparatus (23) comprising at least one pressure channel (24) enabling to provide at least one filter unit (19a) to be cleaned with a pressure pulse, the direction of which is reverse in comparison with the conventional filtering flow, whereby the pressure pulse is arranged to remove the solid matter (21) in the filter (20), and
at least one control unit (33) for controlling the operation of the cleaning apparatus (23),
characterized in that
the cleaning apparatus (23) comprises mechanical sealing means (26) for preventing the filtering flow through at least one filter unit (19a) to be cleaned during cleaning, and
the control unit (33) is arranged to keep the filter unit (19a) to be cleaned sealed for a predetermined time after having provided the pressure pulse.

13. A rock drilling rig as claimed in claim 12, characterized in that
the control unit (33) is arranged to perform the cleaning of the filter units (19) during drilling.

14. A rock drilling rig as claimed in claim 12 or 13, characterized in that
the rock drilling rig comprises means for determining the magnitude of the suction, and
the control unit (33) is arranged to keep the filter unit (19a) to be cleaned sealed for the sealing time, the length of which is proportional to the magnitude of the suction.
